(19) United States
(12) Patent Application Publication
(10) Pub. No.: US 2023/0206175 A1
(43) Pub. Date: Jun. 29, 2023

(54) DISTRIBUTED NETWORK OF ORDER SYSTEMS

(71) Applicant: CFPH, LLC, New York, NY (US)

(72) Inventors: Jed Kleckner, New York, NY (US); Jay Winters, New York, NY (US); Olivier Hepner, New York, NY (US)

(21) Appl. No.: 18/177,808

(22) Filed: Mar. 3, 2023

Related U.S. Application Data
(63) Continuation of application No. 17/853,042, filed on Jun. 29, 2022.
Application No. 17/853,042 is a continuation of application No. 15/665,816, filed on Aug. 1, 2017, now abandoned.
(60) Provisional application No. 62/370,056, filed on Aug. 2, 2016.

(51) Int. Cl. G06Q 10/087; G06Q 20/20; G06Q 20/04; G06Q 20/12; G06Q 20/24; G06Q 20/40; G06Q 20/42

(52) U.S. Cl. CPC G06Q 10/087; G06Q 20/04; G06Q 20/12; G06Q 20/24; G06Q 20/40; G06Q 20/42; G06Q 20/203; G06Q 30/0609

(57) ABSTRACT

Some embodiments include receiving a plurality of items available for purchase; aggregating the plurality of items into a menu; populating a first interface configured for ordering; receiving an order; requesting delivery quotes to deliver the order to the customer; receiving the delivery quotes to deliver the order to the customer; populating a second interface with information defining the order, requesting confirmation of the order and selection of a delivery network to deliver the order to the customer; populating the second interface with at least one of cost and time from the delivery quotes; receiving a confirmation of the order and a selection of a delivery network to delivery network; notifying the customer of the confirmation and an estimate of a time for delivery of the order; facilitating delivery of the order to the customer using the delivery network; and processing payment for the order and payment for delivery.

### CROSS-REFERENCE TO RELATED APPLICATIONS

This application is a continuation of U.S. Pat. Application No. 17/853,042 filed Jun. 29, 2022, which is a continuation of U.S. Pat. Application No. 15/665,816 filed Aug. 1, 2017, which claims priority to U.S. Provisional Application No. 62/370,056 filed Aug. 2, 2016, each of which is hereby incorporated herein by reference in its entirety.

### FIELD

Some embodiments may relate to communication networks and order systems.

### BACKGROUND

Communication networks allow customers to communicate order information to merchants. Delivery of goods may be made to customers. Mobile devices (e.g., smartphones, tablets, laptops, cellphones, and so on) are becoming increasingly ubiquitous and sophisticated.

### SUMMARY

The following should be interpreted as example embodiments and not as claims.

Some embodiments include an apparatus comprising: a network link; a computing device; a non-transitory medium having store thereon a plurality of instructions that when executed cause the apparatus to: receive, through the network link from a merchant computing system, a plurality of items available for purchase from the merchant; aggregate the plurality of items into a menu for the merchant; populate a first interface configured for ordering from the merchant at a plurality of remote client devices; receive, through the network link, an order for the merchant for a customer and from a remote client device of the plurality of remote client device; in response to receiving the order, request, through the network link from a plurality of delivery network systems, delivery quotes to deliver the order to the customer; receive, through the network link and from the plurality of delivery network systems, the delivery quotes from the delivery network systems to deliver the order to the customer; in response to receiving the order, populate a second interface for managing orders with information defining the order, requesting confirmation of the order and requesting selection of a delivery network to deliver the order to the customer; in response to receiving the delivery quotes, populate the second interface with at least one of cost and time from the delivery quotes for at least one of the plurality of delivery network systems; receive, through the communication link, a confirmation of the order entered through the second interface and a selection of a delivery network to delivery network to deliver the order to the customer; in response to receiving the confirmation and the selection of the delivery network, notify, through the communication link, the customer of the confirmation and an estimate of a time for delivery of the order by the delivery network; in response to receiving the confirmation and the selection of the delivery network, facilitate, through the communication link, delivery of the order to the customer using the delivery network; and process payment for the order to the merchant and payment for delivery of the order to the delivery network using payment information of the customer.

In some embodiments, the computing device includes a plurality of computing devices, and the non-transitory medium includes a plurality of non-transitory media. In some embodiments, the items include food items, and the merchant includes a restaurant. In some embodiments, which the first interrace includes at least one of a website and a mobile application interface. In some embodiments, the order identifies a location of the delivery, the payment information and items to be delivered. In some embodiments, each delivery quote identified at least one of cost to deliver the order to the customer and an estimated time of delivery of the order to the customer. In some embodiments, populating the second interface with at least one of cost and time from the delivery quotes for at least one of the plurality of delivery network systems includes populating the second interface with a time estimate for delivery of the order to the customer. In some embodiments, populating the second interface with at least one of cost and time from the delivery quotes for at least one of the plurality of delivery network systems includes populating the second interface with a cost for delivery of the order to the customer. In some embodiments, the second interface includes an interface of a merchant terminal. In some embodiments, populating the second interface with the at least one of cost and time includes populating the second interface with the at least one of cost and time after populating the second interface with the information defining the order. In some embodiments, populating the second interface with the at least one of cost and time includes populating the second interface with the at least one of cost and time while populating the second interface with the information defining the order. In some embodiments, the confirmation of the order and the selection of the delivery network are received together. In some embodiments, notifying the customer of the confirmation and the estimate includes populating a third interface with the estimate of the time based on a quote from the delivery network. In some embodiments, facilitating delivery includes transmitting a request to deliver the order to the delivery network system of the delivery network.

Some embodiments include a method comprising: receiving, by a computing device through a network link from a merchant computing system, a plurality of items available for purchase from the merchant; aggregating, by the computing device, the plurality of items into a menu for the merchant; populating, by the computing device, a first interface configured for ordering from the merchant at a plurality of remote client devices; receiving, by the computing device through the network link, an order for the merchant for a customer and from a remote client device of the plurality of remote client device; in response to receiving the order, requesting, by the computing device through the network link from a plurality of delivery network systems, delivery quotes to deliver the order to the customer; receiving, by the computing device through the network link and from the plurality of delivery network systems, the delivery quotes from the delivery network systems to deliver the order to the customer; in response to receiving the order, populating, by the computing device, a second interface for managing orders with information defining the order, requesting confirmation of the order and requesting selection of a delivery network to deliver the order to the customer; in response to receiving the delivery quotes, populating, by the computing device, the second interface with at least one of cost and time from the delivery quotes for at least one of the plurality of delivery network systems; receiving, by the computing device through the communication link, a confirmation of the order entered through the second interface and a selection of a delivery network to delivery network to deliver the order to the customer; in response to receiving the confirmation and the selection of the delivery network, notifying, by the computing device, through the communication link, the customer of the confirmation and an estimate of a time for delivery of the order by the delivery network; in response to receiving the confirmation and the selection of the delivery network, facilitating, by the computing device through the communication link, delivery of the order to the customer using the delivery network; and processing, by the computing device, payment for the order to the merchant and payment for delivery of the order to the delivery network using payment information of the customer.

### BRIEF DESCRIPTION OF THE DRAWINGS

FIG. 1 depicts a system that may be used in some embodiments.

FIG. 2 illustrates an example method that may be performed in some embodiments.

FIG. 3 illustrates an example method that may be performed in some embodiments.

FIG. 4 illustrates an example method that may be performed in some embodiments.

FIG. 5 illustrates an example method that may be performed in some embodiments.

FIG. 6 illustrates an example interface screen that may be used in some embodiments.

### DETAILED DESCRIPTION

U.S. Pat. publication 2008/0161944 entitled Method and Apparatus for Group Filtered Reports, U.S. Pat. publication 2008/0195538 entitled Payment During Trial Period of Referral Service, U.S. Pat. publication 2009/0083135 entitled Products and Processes for Revenue Sharing, U.S. Pat. publication 2009/0083324 entitled Method and Apparatus for Menu Generation, U.S. Pat. application 13/023,740 entitled Multi-system Distributed Processing of Group Goals, and U.S. Pat. application 14/540,777 entitled Examples of Delivery and/or Referral Services are all hereby incorporated herein by reference. Any embodiments described in one or more of such patent applications and/or herein may be used in any combination with one or more embodiments described herein in any combination.

It is recognized that one or more of a customer, merchant, delivery agent and/or other entity engaged in the fulfilment and/or placement of an order may utilize a computing device. For example, mobile devices (e.g., smartphones) may include cameras, gyroscopes, GPS devices, touch screens, accelerometers, internet connections, and so on. Such devices may include processors and/or memory capable of providing services that might not have been possible without the use of these devices. Other example devices and functionality may be used in various embodiments.

Communication of information to or from one or more computing devices may take any desired form. For example, order information may be transmitted to a merchant, confirmation information may be transmitted from a merchant, time estimate information may be transmitted from a merchant, time estimate information may be transmitted from a delivery agent, time request information may be transmitted to a merchant, time request information may be transmitted from a merchant, payment information may be transmitted to a merchant, special request information may be transmitted to the merchant, credit authorization may be transmitted to the merchant, reservation information may be transmitted to/from a merchant, delivery information may be transmitted to/from a merchant/delivery agent, payment information may be transmitted, and so on. Such information may be transmitted to and/or from a communication device (e.g., a computer, a cell phone, a fax machine, an email client, a SMS client, a POS terminal, etc.) associated with a merchant, a customer, a delivery person and/or any entity involved in an order. A merchant, for example, may include a restaurant, a grocery store, and/or a merchant that provides any goods and/or services.

Some embodiments may include methods and apparatus related to a referral service. Some embodiments of such a service may receive an indication of an order for a merchant from a user of the service and may forward the indication of the order to the merchant.

It should be recognized that the term facilitate and derivations thereof are used herein in an extremely broad sense. Such terms may be used to include any action that may directly, and/or indirectly bring about and/or help to bring about a thing. For example facilitating transmission may include allowing a transmission, transmitting, transmitting directly, transmitting indirectly, any action that may aid in transmission, and so on.

An indication of a payment may include, for example, one or more of an indication that a payment has been made, an indication that a payment has been authorized, an indication of approval of a payment, an indication of an amount of a payment, and / or an indication of a promise to make a payment in the future. In some implementations, an indication of a payment may include an indication that a payment has been made to a desired money account. In some implementations, the indication may be received from an entity making or processing a payment to the desired money account (e.g., a bank, a credit card company, a money transferor, a payment processing service). In some implementations, the indication may be received from an entity receiving the money (e.g., a bank, a credit card company, a money transferor, a payment processing service). In some implementations, the indication may be received after the money is authorized to be transferred into the desired account but before the money is transferred / received. In some implementations, the indication may be received after the money is transferred into / received at the desired account.

Some embodiments may include collection of a payment. For example, in some embodiments, a delivery agent may collect a promised payment upon delivery and/or pickup, a credit card may be charged an authorized amount, and so on. In some embodiments, a payment agreed upon initially may be changed later, such as to add a tip, adjust for undelivered items, refund for a coupon, and so on. Some embodiments may further include distributing the collected payment among one or more entities, such as the delivery agent, a merchant, a referral service, a payment processing service, and so on.

Some embodiment may enable efficient management of customer ordering, sales processing and/or delivery facilitation. Point of sales devices may be combined with access to external facing menu servers that allow customer ordering and last mile provider networks that allow delivery control. A single point of sale management solution may allow vast control over order processing for a merchant in a single location and/or interface.

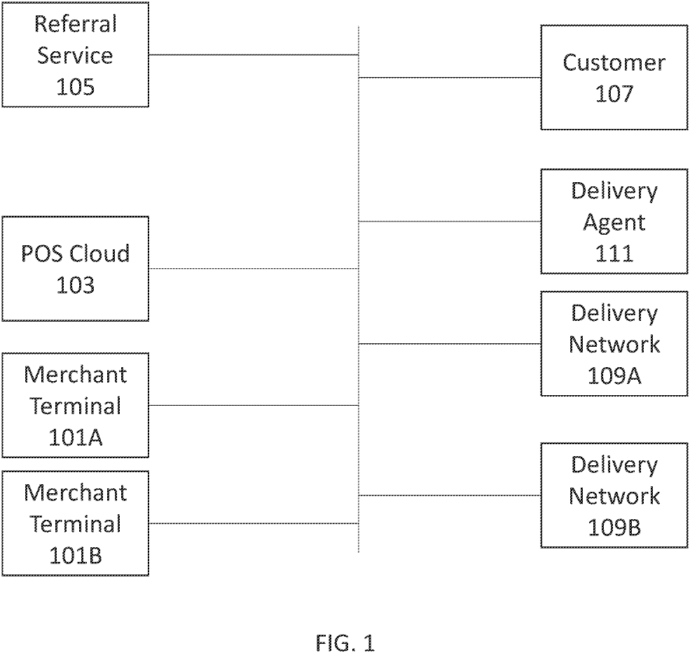

FIG. 1 illustrates an example system that may be used in some embodiments. Elements of such a system may be coupled together by one or more networks. Such networks may include the Internet, LANs, WANs, Wi-Fi network, wired networks, and so on in any desired combination. The illustrated example of FIG. 1 shows an embodiment that uses a cloud based arrangement. Other embodiments may include other arraignments, such as an arrangement where data storage and/or processing occurs at a merchant location rather than at a cloud based location. Accordingly, it should be recognized that arrangements of data storage and processing are given as examples only and that actual arrangements may vary as desired.

As indicated in FIG. 1, some embodiments may include one or more merchant terminals 101A and 101B. A merchant terminal may include a computing device. A merchant terminal may be configured to execute instructions that control the computing device to provide point of sale functionality to a merchant. Such functionality may be provided in coordination with one or more other devices that may be remote from the merchant terminal (e.g., a point of sale cloud, application provider devices, credit processors, etc.). A merchant terminal may execute an operating system (e.g., Linux, Windows) and/or base level of services that enable basic functionality. In some implementations, a user may install further apps to extend the functionality of the merchant terminal as desired. Some example point of sale terminals include those available from Clover, which has offices in Sunnyvale, California.

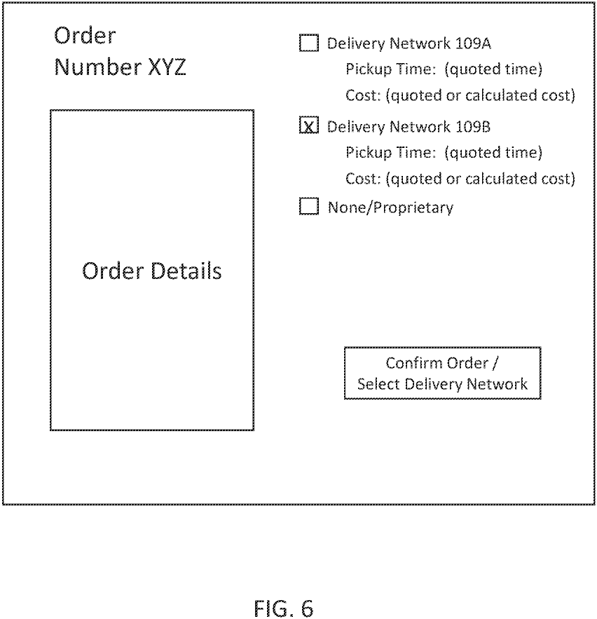

In some implementations merchant terminal 101A may include an interface through which order management may performed by a merchant. For example, a front office staff may receive orders, confirm orders, process orders, revive payment information, process payment information, receive delivery quotes, process delivery quotes, and/or perform order processing of any desired sort through merchant terminal 101A. Merchant terminal 101A may receive and/or transmit information to other devices to enable functionality. Merchant terminal 101A may provide a merchant with an interface such as that illustrated in FIG. 6.

In some implementations merchant terminal 101B may include an interface through which order processing may be performed by a merchant. For example, a kitchen or back office staff may revive order information (e.g., after an order is confirmed/processed by a front office). Such functionality may allow a seamless processing of an order by a merchant where a front office performs front office functionality through a merchant terminal 101A, and a back office or kitchen is notified/performs back office or kitchen functionality through merchant terminal 101B. Merchant terminal 101B may receive and/or transmit information to other devices to enable functionality.

It should be recognized that such a two terminal implementation is given as an example only. Other implementations may include more or fewer terminals that provide similar or different functionality to enable order fulfilment.

As indicated in FIG. 1, some embodiments may include point of sale cloud service 103. A point of sale cloud service may provide one or more API’s that enable application communication (e.g., among applications, with an application and cloud infrastructure services, etc.). A point of sale cloud service may enable functionality of a merchant terminal 101. A point of sale cloud service may enable communication between and/or among service providers and a merchant terminal. A point of sale cloud service may provide infrastructure functionality (e.g., storage, communication, etc.). A point of sale cloud service may operate as a web service, may operate through the execution of one or more servers, blades, computing devices, etc. One example point of sale cloud service includes the Clover point of sale system.

As indicated in FIG. 1, some embodiments may include a referral service provider 105. A referral service provider may provide order referral services for one or more merchants through point of sale cloud service 103. A referral service provider may make items orderable from the merchant by customers, communicate orders received from customers to merchants, track orders, confirm orders, facilitate delivery and/or provide any desired functionality. A referral service provider may communicate directly with one or more merchant terminals and/or service providers in some implementation. A referral service provider may communicate with one or more merchant terminals and/or service providers through a point of sale cloud service in some implementations. A referral service provider may include one or more servers or other computing devices that may execute one or more programs to provide order referral functionality. One example of a referral service provider may include Delivery.com of New York, New York.

In some implementations, a referral service provider 105 may obtain menu and/or inventory information from a merchant (e.g., by accessing that information at a point of sale cloud service through an API). Referral service provider 105 may publish this information (e.g., in the form of a website or application interface that allows ordering. For example, a menu of items available from a merchant may be present through an interface that allows a customer to select items and place an order for those items. In response to a customer placing such an order, a referral service provider 105 may transmit order information to the merchant (e.g., by transmitting to a point of sale cloud service using an API). Payment information may be separately processed and/or processed together with order information (e.g., a point of sale cloud service may provide payment processing of the order for a credit card order, a merchant or delivery agent may perform a payment processing for a cash order, etc.). One or more confirmation actions for an order may be performed by a referral service provider 105 (e.g., confirming that the merchant accepts the order, confirmation that the order was accepted, etc.).

As indicated in FIG. 1 some embodiments may include a customer 107. A customer may include a person that orders goods and/or services from a merchant. A customer may use a computing device such as a general purpose computer, a smart phone and so on to access a menu of a merchant, select items offered by the merchant, enter payment information for the items, enter delivery information, place the order, track the order, receive confirmation of the order, and so on. Information may be transmitted between a customer device and a referral service provider to facilitate such an interaction. For example, a customer may use a smartphone app or may access a webpage that presents an interactive menu of a merchant served by the referral service provider (e.g., through a web server). The smartphone may transmit information entered by the customer to the referrals service provider (e.g., credit card number, address, items selected, etc.). The smartphone may receive information from the referral service provider (e.g., items available, confirmation of order placement, etc.) and display that information to the customer.

As indicated in FIG. 1, some embodiments may include one or more delivery networks 109A and 109B. A delivery network may include a service that provides delivery services. A delivery network may operate any number of delivery agents to deliver items from one location to another location. Such delivery networks may include on demand same day delivery networks. One example delivery network includes Uber of San Francisco, California. A delivery network may receive information about an order, may quote a cost of providing delivery services, may arrange delivery services for the order through one or more delivery agents, and/or may provide any desired functionality. For example, in some embodiments, a delivery network may be asked to quote a time (and/or price) for an order received through a referral service provider (e.g., through an API of a point of sale cloud service, through an API of the delivery network). Information about the order (e.g., size, destination, source, special instructions, etc.) may be transmitted to the delivery network. The delivery network may respond by quoting the time (and/or price) for perform the delivery (e.g., using the API of a point of sale cloud service, using an API of the delivery network). In some embodiments, a delivery network may be assigned a delivery job (e.g., by a merchant choosing the delivery network through a merchant terminal based on a quote). In response, a transmission may be received by the delivery network (e.g., through the point of sale cloud service API, through the delivery network API) indicating details of the delivery job and that the delivery network should perform he delivery. In response, the delivery network may contact one or more delivery agents to facilitate delivery of the order. The delivery network and/or other element of a system of FIG. 1 may process payment to the delivery network for performing the delivery.

The illustrated embodiment shows two delivery networks 109A and 109B. It should be recognized that various embodiments may include any number of delivery network arranged in any manner. Some may have their own API’s while other may use a point of sale cloud service provider’s API. Some may communicate through a point of sale cloud service provider while other may communicate directly with a merchant and/or referral service provider. Multiple delivery networks may allow a merchant to determine an appropriate price and/or time for a delivery from among a plurality of possible delivery options. For example one network may be able to deliver an order faster than another at a higher price. By quoting and offering multiple networks, a point of sale cloud service provider may allow the merchant the flexibility to choose which network is best for its needs at the price point that is reasonable. In addition, multiple delivery networks may allow for a backup option in the case where a delivery network is unable to perform delivery.

As indicated in FIG. 1, some embodiments may include a delivery agent 111. The delivery agent 111 may include an employee or contractor of a delivery network. For example, the delivery agent may be an Uber driver. The delivery agent may be assigned a delivery job by a delivery network. Information about the delivery job (e.g., time, pickup location, price, drop off location, special instructions, directions, etc.) may be communicated to the delivery agent through a computing device of the delivery agent. For example, a smartphone running an Uber or other delivery network application may be used to assign a job to the deliver agent. A delivery network may facilitate payment to the delivery agent for performing the delivery. The delivery agent, in response to being assigned a delivery job for an order (e.g., an order placed through a referral service provider) may perform delivery services for the order (e.g., pick the order up from the merchant and drop the order off with the costumer).

It should be recognized that the example of FIG. 1 is given as a non-limiting example only. Other embodiments may include a similar or different components and/or arrangement of components. For example, although the example includes a cloud service provider, other embodiments may not use such an element. Components in such a non-cloud environment may communicate directly with one another rather than through a cloud service provider. As another example, service providers to a cloud that are shown may in fact be part of a cloud infrastructure rather than external providers. Service providers could provide multiple services such as referral and delivery together as one provider rather than separate providers. APIs could be unidirectional, bi-directional, provided by a service provider, provided by a cloud provider, etc. There could be additional and/or different service providers and/or infrastructure services such as payment processors, receipt creators, order tracking, tax accounting, inventory management, and so on. Quoting of times and/or prices for a delivery network may take any desired form. For example, times and/or prices may be quoted by a delivery network in response to a query. As another example, a price may be otherwise determined from a pricing chart based on distance. For example, a merchant terminal, a cloud service provider, a referral service provider or some application running on one or more of such elements may determine a price from a source and destination of an order by referencing such a chart. A time may be quoted by querying a delivery network. It should be recognized that these variations are given as non-limiting examples only and that other variations and combination fall within the scope of this disclosure.

In some embodiment, an application may provide a merchant with referral services and delivery services in a convenient package at a point of sale terminal. A merchant may enter information regarding items sold by the merchant into a terminal (e.g., names, pictures, descriptions, prices, etc.). In a cloud based environment, that information may be transmitted to a point of sale cloud service provider through an API. That information may be stored in a database so that it may be accessed later (e.g. by calls through the API). The information may be updated as inventory and/or offered items change from time to time (e.g., daily specials).

A merchant may install and/or authorize an application to act as a referral service provider for the merchant. In response, a referral service provider may receive inventory information (e.g., by making a call to a point of sale cloud service provider asking for the information). The referral service provide may use the information received to create and publish an ordering interface that customers may use to place orders for the merchant. A customer may access the interface and place an order.

In response to a customer placing an order, the referral service provider may write an order through the cloud service provider API. In response, the point of sale cloud service provider may then push the order to the merchant terminal. The merchant terminal may display information about the order to the merchant in an order interface. The point of sale cloud service provider, referral service provider, and/or application may obtain a delivery quote from one or more delivery networks. The delivery quote may be shown to the merchant through the order interface. The merchant may confirm the order and/or chose a delivery network to fulfill the order through the order interface.

Confirming the order may result in a write to the cloud service provider (e.g., using the API) that is subsequently pushed to the referral service provider. The referral service provider may then notify the customer that the order is confirmed. Such confirming may include an estimate of delivery time obtained from a quote by a chosen delivery network.

Selecting a delivery network may result in the point of sale cloud service provider, application and/or referrals service communicating with the delivery network (e.g., through an API) informing the network to perform the delivery.

In response, the delivery network may act to perform the delivery. The merchant may act to prepare the order. The point of sale cloud service provider may act to process payment. The customer may receive the order. Accordingly, such a system may enable a merchant interface as a single application to act on incoming delivery orders in a robust end to end manner.

It should be recognized that these are examples of an application are given as non-limiting examples only. Other embodiments may include fewer, more, different, similar and so on features and/or structures. For example, in some embodiments tracking services may be provided to a merchant and/or customer. As another example, methods of communicating form one element to another may differ from embodiment to embodiment. As yet another example, an element responsible for one functionality may differ from embodiment to embodiment. In some embodiments a quote may be obtained by a merchant terminal. In others by a cloud service provider. In others by a referral service provider. In others by some other element. It should be recognized that these variations are given as non-limiting examples and that other arrangements and combinations are contemplated by this disclosure.

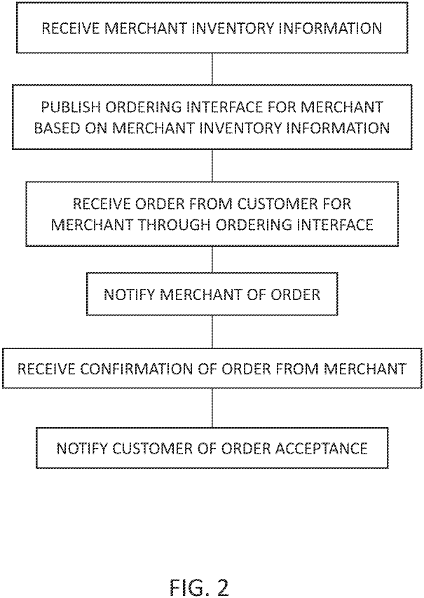

FIG. 2 illustrates an example method that may be performed in some embodiments. For example, a referral service provider 105 may perform such a method in some embodiments by executing a program by one or more servers. Such a method may enable a referral service to publish a menu of orderable items for a merchant and receive orders from customers. Any number of merchants may have such menu information published and any number of customers may use such menus to place orders with those merchants. A merchant may install and/or enable a referral service functionality through merchant terminal (e.g. by installing and authorizing an application through the merchant terminal). In response, a referral service may be notified and perform such a method by interacting with a point of sale cloud service and/or merchant device. For example, a merchant may authorize a referral service through a merchant terminal and in response a point of sale cloud service provider may notify the referral service and/or provide the referral service with information (e.g., merchant inventory information).

As indicated, some embodiments may include receiving merchant inventory information. Such information may be received in any manner. Merchant inventory information may include information identifying items that are available for sale by a merchant. Merchant inventory information may include information describing and/or defining items for sale by a merchant. For example, merchant inventory information may include names of items, prices of items, categories of items, pictures of items, descriptions of items, and/or any other information that may be useful to create a menu of items.

For example, the information may be received directly from a merchant (e.g., an inventory management or point of sale system of a merchant). An API of the referral service and/or of a merchant system may enable a merchant to communicate such information into the referral service. As another example, the information may be received from a point of sale cloud service. The point of sale cloud service may receive the information from the merchant (such as when a merchant begins using the point of sale cloud service, periodically, in response to a change, etc.). An API of the point of sale cloud service may enable such information from a merchant terminal to be written into the point of sale cloud service. The information may be stored there and made accessible to other service providers. The API of the point of sale cloud service may allow the referral service to read the information. The referral service may access the point of sale cloud service to retrieve the information. In some implementations, a referral service may pull such information from a point of sale cloud service (e.g., in response to a merchant enabling referral services, periodically, etc.). In some implementations, a point of sale cloud service may push such information to a referral service (e.., in response to changes, in response to a referral service registering to listen to such information, etc.)

In some embodiments, a merchant may make updates to an inventory (e.g., running out of a product, adding a special, and so on). In some embodiments, such a change may be entered into a merchant terminal by an employee using an interface of the merchant terminal, may be determined based on a sale adjusting an inventory number to zero so that the item is no longer available, and/or may be made in any desired manner. In response, such updated information may be communicated to the referral service (e.g., using a pull and/or push of information), which may in turn act upon that changed information to update published menu information.

As indicated, some embodiments may include publishing an ordering interface for a merchant based on the merchant inventory information. A menu of items may be determined based on the receive information. Such a menu may include a listing of items with information about the items (e.g., organize into category, a set of price and name pairings, and so on). A variety of menu arrangements are known and may be used as desired. Such a menu may be published through a web server so that the menu may be access when a URL is accessed by a web browser. The ordering interface may be published when a through a server so that a web or other app such as an application on a smartphone or otherwise may pull the menu from the server. Publishing such an ordering interface may include providing an interactive interface that allows the placement of an order for items from the merchant (e.g., selection of items, entry of order destination, entry of payment information, and so on).

Any number of customers may access the menu to view the available items from the merchant (e.g. by using an application and/or web browser). A customer may interact with the menu to select items for an order (e.g., add items to a shopping cart). A customer may interact with the menu to enter order destination details and payment details (e.g., by filling out a form).

As indicated, some embodiments may include receiving an order from a customer for the merchant entered through the ordering interface. Information defining the order (e.g., items ordered, payment information, destination of order, merchant identifier, etc.) may be received from a customer (e.g., a computing device used by the customer to access a published ordering interface). Such information may be received in response to the user entering it into the published ordering interface. A customer may place any number of orders with any number of merchants. Any number of customers may place such orders through an ordering interface. A referral service may receive such orders and act on them accordingly.

As indicated, some embodiments may include notifying the merchant of the order. Such notification action may take place in response to receiving the order from the customer. In some embodiments, a merchant may be notified directly (e.g., by communication with a merchant terminal using an API of a merchant and/or referral service). In some embodiments, a merchant may be notified through a point of sale cloud service. For example, a referral service may use an API of a point of sale cloud serve to transmit information about the order to the point of sale cloud service. A merchant may then receive such information from the point of sale cloud service (e.g., by a push to the merchant and/or a pull by the merchant).

Notifying the merchant may include providing information to populate a referral order interface of a merchant terminal to the merchant, causing the merchant terminal to display information about the order, requesting a confirmation of the order from the merchant, and/or any other desired actions. For example, notifying a merchant may include providing a listing of items that are ordered by the customer, providing a payment amount/details, providing an order destination, providing an order identifier, and so on. Notifying a merchant may include controlling an interface such as that of a merchant terminal to display information about the order. Notifying a merchant may include requesting a confirmation of the order (e.g., by controlling an interface to enable a confirmation control such as a button). FIG. 6 illustrates an example referral order interface that may be used to notify a merchant of an order.

As indicated, some embodiments may include receiving confirmation of the order from the merchant. Such confirmation may be received in response to the merchant confirming the order through a merchant terminal (e.g., actuating a confirmation control such as a button). In some embodiments, a confirmation may be received directly from the merchant (e.g., by communication with a merchant terminal using an API of a merchant and/or referral service). In some embodiments, a confirmation may be received through a point of sale cloud service. For example, a referral service may use an API of a point of sale cloud serve to receive information about the confirmation from the point of sale cloud service (e.g., by a push or pull from the point of sale cloud service). A merchant terminal may similarly use such an API of a point of sale cloud service to communicate the confirmation to the point of sale cloud service in response to the confirming the order through a merchant terminal. In some implementations, a point of sale cloud service may push such a confirmation to a referral service in response to receiving the information from the merchant.

A confirmation may indicate that the order is confirmed by the merchant. An order indicator may identify the order between elements of a system such as a merchant, referral service and/or point of sale cloud service. A confirmation may use the indicator to identify the order. A confirmation may include other information as desired (e.g., time estimate, tracking information, request to provide delivery service, selection of delivery network, price adjustment, etc.).

As indicated some embodiments may include notifying the customer of the order acceptance. Notifying the customer may be performed in response to receiving the confirmation from the merchant. Notifying the customer may include transmitting an indication that the order has been placed to the customer (e.g., to a computing device used to place the order, to an email address, to a smartphone, etc.). Notifying the customer may include providing additional information to the customer such as delivery estimate, price adjustments, an indication of a delivery agent, and so on.

It should be recognized that this method is given as a non-limiting example only. Other embodiments may include no such method, a similar method, a different method, a differently ordered method, a longer method a method with different actions, and so on. For example, in some embodiments a method may include a referral service provider determining quotes from a delivery network and providing that information to a merchant (e.g., directly and/or through a point of sale cloud service). Some embodiments may include a referral service receiving a selection of a delivery network and coordinating with the delivery network to provide the delivery services (e.g., by communicating information about the order through an API of a delivery network). Such examples are non-limiting. Such a method may be combined with other elements in any combination as desired.

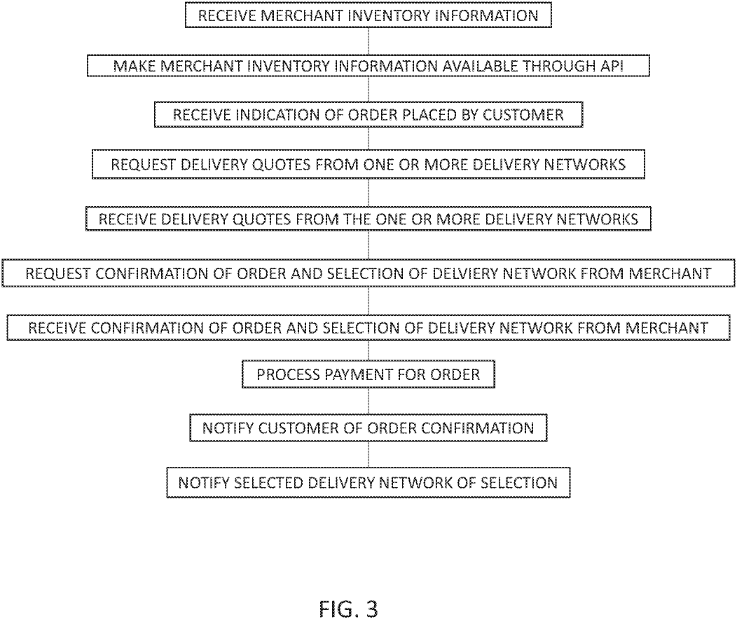

FIG. 3 illustrates an example method that may be performed in some embodiments. For example, a point of sale cloud service 103 may perform such a method in some embodiments by executing a program by one or more servers. Such a method may enable a merchant to receive orders from a referral service and arrange delivery of the orders. Any number of merchants may use such a point of sale cloud service and any number of customers may use a referral service to place orders with those merchants. A merchant may install and/or enable a point of sale system and/or a referral service functionality through merchant terminal (e.g. by installing and authorizing an application through the merchant terminal). In response, a point of sale cloud service may be notified and perform such a method by interacting with a referral service, delivery network and/or merchant terminal.

As indicated, some embodiments may include receiving merchant inventory information. Such information may be received in any manner. Merchant inventory information may include information identifying items that are available for sale by a merchant. Merchant inventory information may include information describing and/or defining items for sale by a merchant. For example, merchant inventory information may include names of items, prices of items, categories of items, pictures of items, descriptions of items, and/or any other information that may be useful to create a menu of items.

Such information may be received directly from a merchant (e.g., an inventory management or point of sale system of a merchant). An API of a point of sale cloud service may enable a merchant system to communicate such information into the point of sale cloud service. The point of sale cloud service may receive the information from the merchant (such as when a merchant begins using the point of sale cloud service, periodically, in response to a change, etc.). The information may be stored by a point of sale cloud service (e.g., by one of more machine readable medium and/or servers).

Such information may be received from a merchant terminal in response to the information being entered and/or updated through the merchant terminal (e.g., by a merchant, in response to an inventory change, etc.). For example, upon an initial setup of a service, a merchant may enter an inventory of items for sale by the merchant. As another example, occasionally, (e.g., as inventory changes, as new specials are made available, as prices change, daily, as new items become available, etc.) a merchant may make a change to an inventory. In response to such situation and/or other situations that may affect inventory available from the merchant), a merchant terminal may transmit information to a point of sale cloud service (e.g., through an API call). The point of sale cloud service may receive the information (e.g., through a network formatted to be understood as a call to the API).

As indicated, some embodiments may include making the merchant inventory information available through a point of sale cloud service API. The merchant inventory information may be made available in response to receiving the merchant inventory information and/or in response to receiving an authorization to make the information available. For example, in some embodiments, a merchant may authorize specific services to receive the merchant inventory information (e.g., by entering information through a merchant terminal that is then received by a point of sale cloud service). In response to such authorization, the point of sale cloud service may make the inventory information available to the authorized specific services (e.g., notify the services, allow the services to read the information through API calls, etc.). In some implementations such specific authorization may not be used (e.g., for any, for some, for all services). Rather, the merchant inventory information may be made available to a service without specific authorization of that service from a merchant. It should be recognized that any arrangement and combination of authorizing services may be used as desired.

Making the merchant inventory information available may include any combination of actions. For example, embodiments may include pushing the information to services, responding to API calls for the information by sending the information to requesting services, notifying services that the information is available to them, and/or any desired action. For example, a referral service may be notified that inventory information of a merchant is available to the referral service merchant. The notification to the referral service may take place through an API (e.g., a transmission to the referral service). The point of sale cloud service may enable the referral service to make API calls to read the merchant inventory information (e.g., authorizing such calls, marking a database to indicate that the referral service is authorized, etc.). The point of sale cloud service may then respond to an API call from the referral service by providing the merchant inventory information. As another example, the point of sale cloud service may push the information to the referral service through an API (e.g., of the cloud service provider and/or referral service). Any combination of pushing and/or pulling may be used to transmit such information (e.g., an initial pull followed by pushes in response to changes, pulls occasionally by the referral service, pushes up receipt of information, etc.). This may enable the referral service to receive the merchant inventory information so that it may be acted on in a desired manner (e.g. made available for customers to place orders).

As indicated, some embodiments may include receiving an indication of an order placed by a customer. Such an indication may be received from a referral service through an API call made in response to receiving the order from the customer. The indication of the order may include information about the order that may be relevant to filling and/or tracking the order. For example, such information may include a listing of items ordered, a method of payment, an order destination, a merchant identifier, an order identifier, and so on.

Some embodiments may include taking any number of desired action in response to receiving an indication of an order. Some such examples are illustrated in FIG. 3. Various example s actions may include bond a delivery agent, tracking an order, storing order information, making order information available to other services, providing auditing information, providing receipt services, and so on. It should be recognized that a point of sale cloud service may provide any desired order related services in response to receiving an order.

As indicated, some embodiments may include requesting delivery quotes from one or more delivery networks. In some embodiments, such requesting may take place in response to receiving an indication of an order placed by a customer (e.g., if the order is an order for delivery rather than an order for pickup. In other embodiments, such requesting may take place in response to a request by a merchant to provide delivery information. A request may include a request for a time and/or a request for a price to deliver an order from a merchant to a customer (and/or other designated destination for the order).

Making such a request may include using an API (e.g., of a point of sale cloud service and/or a delivery network) to transmit information to one or more delivery networks. For example, an Uber API may be used to request a quote from Uber by transmitting information in a form as designated by the API. Transmitted information may include a location of a merchant and/or a location for a drop off (e.g., a location of the customer). Any other desired information may be transmitted that may help facilitate a quote (e.g., size, special instructions, etc.).

A quote may include a time at which a pickup and/or drop-off may be made. In some embodiments multiple quotes may be used (e.g., different times for different prices). In some embodiments a quote may include a price. In other embodiments a price may be determined otherwise. For example, a price may be otherwise determined from a pricing chart based on distance. For example, a cloud service provider, may determine a price from a source and destination of an order by referencing such a chart.

It should be recognized that requesting elements of a quote and/or determining elements of a quote are given as a non-limiting example only. Any manner of determining a time and/or price for one or more delivery networks may be used in various embodiments. Although examples of two delivery networks are given, it should be recognized that any number of delivery networks may be used. Different forms and/or API’s may be used with different delivery networks as desired to determine costs and/or prices for such networks. It should also be recognized that a proprietary delivery service of a merchant may be used instead of and/or in addition to a delivery network in some embodiments.

As indicated, some embodiments may include receiving delivery quotes from one or more delivery networks. The delivery networks from which quotes were requested may respond by providing requested information. As described above, a quote may include a price and/or a time. And, as described above, it should be recognized that any manner of determining a price and/or time for a delivery using a delivery network may be used (e.g., looking up in a chart based on distance and/or location). The delivery quote may be received through an API used to request the quote or otherwise (e.g., using the API of a point of sale cloud service, using an API of the delivery network).

In some embodiments, information determined about one or more delivery networks for performing a delivery of an order (e.g., a quoted and/or otherwise determined price and/or time) may be acted up on by a point of sale cloud service provider. For example, such information may be stored and/or made available to other services of the point of sale cloud service provider. For example, such information may be pushed and/or allowed to be queried from a merchant terminal, referral service, etc.

As indicated, some embodiments may include requesting, from a merchant, confirmation of an order and selection of a delivery network. Requesting confirmation may include populating and/or controlling a merchant terminal to display information about the order. Information to populate the interface may be transmitted through an API of a point of sale cloud service. Information may be pushed to the terminal and/or pulled from the terminal. Requesting may include providing a listing of items that are ordered by the customer, providing a payment amount/details, providing an order destination, providing an order identifier, and so on. Communication between a point of sale cloud service provider and a merchant terminal regarding an order may use the order identifier to track the order and actions about the order.

Confirmation and/or selection may be requested in response to receiving the indication of the order and/or in response to receiving and/or determining a quote for a delivery network. Requesting may be part of notifying a merchant of an order having been placed by the customer.

Confirmation and/or selection may be requested separately and/or together, simultaneously and/or sequentially. For example, an interface may display order information and delivery network quotes together. FIG. 6 illustrates an example interface that may be used in some embodiments. As another example, an initial screen may be show while a quote is populated. In such an embodiment, quotes may be requested and/or determined in response to a confirmation and/or before the confirmation is made. As yet another example, one screen may request confirmation and a second screen may request selection of a delivery network. It should be recognized that various arrangements may be used as desired in any combination.

As indicated, some embodiments may include receiving, from a merchant, confirmation of an order and selection of a delivery network. Such confirmation and/or selection may be received in response to the merchant confirming the order through a merchant terminal (e.g., actuating a confirmation control such as a button). In some embodiments. A merchant terminal may use an API of a point of sale cloud service to communicate the confirmation and/or selection to the point of sale cloud service in response to the confirming and/or selecting through a merchant terminal.

A confirmation may indicate that the order is confirmed by the merchant. An order indicator may identify the order between elements of a system such as a merchant, referral service and/or point of sale cloud service. A confirmation may use the indicator to identify the order. Communication between a point of sale cloud service provider and a merchant terminal regarding an order may use the order identifier to track the order and actions about the order. A selection may indicate a delivery network to be used to deliver an order. An identifier of the delivery network may be used to identify the network.

A confirmation and a selection may be received together or separately in any desired order. For example, an indication that the merchant confirmed the order and selected a particular delivery network may be received as an API call form a merchant terminal. In some implementations, a selection may indicate a confirmation (e.g., by selecting a network the merchant may confirm the order). It should be recognized that a variety of arrangements and combinations of receiving confirmation and/or selection may be used.

As indicated, some embodiments may include processing payment for an order. Such payment processing may take place in response to a merchant confirming an order. In other implementations, such processing may take place in response to an order placement and/or order delivery. Payment processing may include using payment information received from a referral service to make a payment for an order. Such a payment may include a payment to a merchant, a payment to a referral service, a payment to a point of sale cloud service, a payment to a delivery network and/or any combination of payments to compensate for services provide. In some implementations, a single payment to a merchant may be made and a subsequent auditing may be made to arrange payments among other providers may be performed. Payment processing may include charging a credit or debit card, performing an ACH on an account, and so on. In some embodiments a cloud service provider may perform such payment processing. In other embodiments, a service provider such as a credit processor may perform such payment processing (e.g. by interacting with an API of a point of sale cloud service provider). Information and/or funds related to a processed payment may be stored, shared, and/or transferred as desired (e.g., transferred to a merchant account, stored in a database, etc.)

As indicated, some embodiments may include notifying the customer of order confirmation. Such notifying may take place in response to a confirmation of the order and/or selection of the delivery network by the merchant being received. In some embodiments, a referral service may be notified, and the referral service may subsequently notify the customer. Notifying the customer may include transmitting an indication that the order has been placed to the customer and/or to the referral service (e.g., through a point of sale cloud service API). Notifying the customer may include providing additional information such as delivery estimate, price adjustments, an indication of a delivery agent, and so on.

As indicated, some embodiments may include notifying a selected delivery network to perform the delivery. Such notification may take place in response to a confirmation of the order and/or selection of the delivery network by the merchant being received. In some embodiments, a referral service may be notified, and the referral service may subsequently notify the delivery network. Notifying the delivery network may include transmitting an indication that the order should be delivered using the delivery network to the delivery network (e.g. through an API of the delivery network, an API of a point of sale cloud service). Notifying the delivery network may include providing information that may be used by a delivery network to make the delivery (e.g., source, destination, special instructions, order identifier, etc.).

It should be recognized that the example of FIG. 3 is given as a non-limiting example only. Other embodiments may include no such method, a similar method, a different method, a differently ordered method, a longer method a method with different actions, and so on. For example, order confirmation may take place before and/or in parallel with delivery quotes being determined. Some embodiments may not include a point of sale cloud based provider. For example, a merchant terminal (or other service) may perform actions described as being taken by a point of sale cloud service. As still another example, one or more actions or services that are descried as being provided one service provider may be provided by another (e.g., one service provider may provide multiple services, referral and delivery may be provide by a same provider, cloud services and referral services may be provided by a same provider, payment processing may take separately from cloud services, etc.). Any customers may place any number of orders with any number of merchants use such a method. In some embodiments, communication between and/or among services may be tracked using an order identifier that is common amount services. Such examples are non-limiting. Such a method may be combined with other elements in any combination as desired.

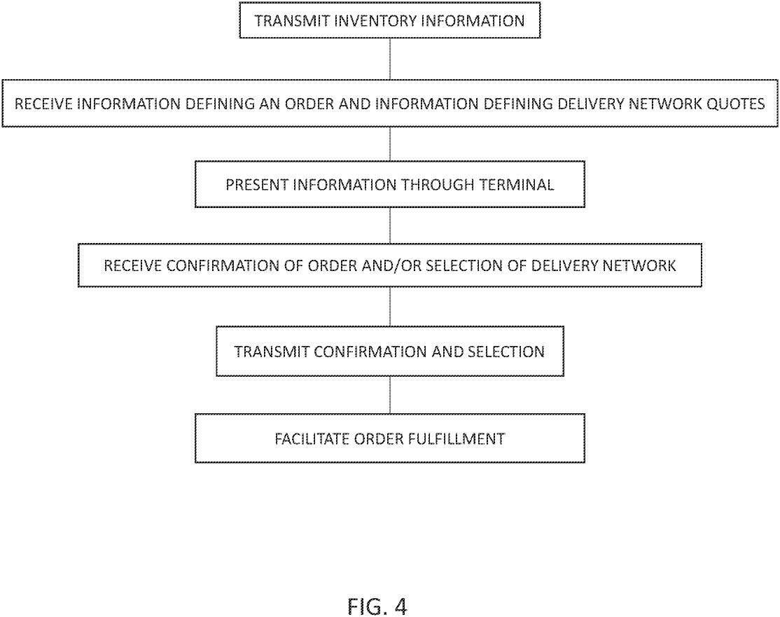

FIG. 4 illustrates an example method that may be performed in some embodiments. For example, a merchant terminal 101 may perform such a method in some embodiments by executing a program. Such a method may enable a merchant to share inventory information and facilitate order fulfillment and delivery. Any number of merchants may use such any number of point of sale terminals that may each use such a method. A merchant may install merchant terminal, enable a point of sale cloud service, enter information regarding inventory, and/or authorize one or more service providers through a merchant terminal (e.g. by installing and authorizing an application through the merchant terminal). In response, a merchant terminal may perform such a method by interacting with a point of sale cloud service and/or other service provider.

As indicated, some embodiments may include transmitting inventory information. Transmitting inventory information may take place in response to receiving inventory information receiving an update to inventory information, receiving a change to inventory information, periodically, upon request, in response to an API call, and so on. For example, in some embodiments, inventory information may be transmitted during an inventory setup process through which a merchant enters inventory information into a merchant terminal and in response to subsequent changes in the inventory. Accordingly, although not indicated in FIG. 4, some embodiments may include receiving inventory information (e.g., receiving an entry of information indicative of inventory of a merchant, changes to the inventory, updates to the inventory, etc.). A merchant terminal may provide an interface through which such information may be entered by a merchant (e.g., an interface through which descriptions, prices, and so on regarding inventory may be entered).

Merchant inventory information may include information identifying items that are available for sale by a merchant. Merchant inventory information may include information describing and/or defining items for sale by a merchant. For example, merchant inventory information may include names of items, prices of items, categories of items, pictures of items, descriptions of items, and/or any other information that may be useful to create a menu of items. In some embodiments, such information may be transmitted to a point of sale cloud service using an API call (e.g., using a syntax and/or format defined by the API). In some embodiments, such information may be transmitted to a service provider (e.g., a referral service, etc.) directly and/or through a point of sale cloud service.

As indicated, some embodiments may include receiving information defining an order and information defining one or more delivery network quotes. Such information may be received from a pint of sale cloud service (e.g., using a push through an API, in response to a pull through the API, etc.) and/or from a referral or other service provider. Such information may be received as a request for confirmation and selection of a delivery network. The information received regarding the order may include a listing of items that are ordered by the customer, a payment amount/details, an order destination, an order identifier, and so on. Communication with a merchant terminal regarding an order may use the order identifier to track the order and actions about the order.

The information regarding one or more delivery networks may include information about a quote of service for the delivery networks (e.g., price, time). Various examples of such quotes are given elsewhere herein. It should be recognized that one or more element of a quote may be determined by a merchant terminal directly rather than received. For example, a merchant terminal may quote by a delivery network for a quote, a merchant terminal may determine a price from a price chart based on location, and so on.

Information regarding an order and information regarding one or more delivery networks may be revived together and or separately. For example, in some embodiments, such information may be received together as a group of information to populate an interface scree with information about order fulfillment. In another example, order information may be received to populate a screen. Subsequently, information about one or more delivery networks may be received (e.g., from a same or different sort) and/or determined. The delivery information may be used to populate the interface screen when and/or after the interface screen is initially presented. Although many examples discuss confirmation of order and selection of delivery network together, in some implementations, delivery information may be sought after and/or in response to an order confirmation. In such an implementation a first interface screen may request confirmation with order information displayed and a second interface screen may request selection of a delivery network with quote information displayed.

As indicated, some embodiments may include presenting order information and information regarding one or more delivery network quotes to a merchant. Information may be presented in response to receiving and/or determining the information, in response to a merchant accessing an order interface, and/or in response to an order confirmation. Information received (e.g., from a point of sale cloud service) may be stored and/or otherwise used to populate an interface.

Displaying order information may be part of a request for confirmation of an order. FIG. 6 illustrates an example interface screen that may be used in some embodiments. For example, information may be presented identifying information about an order (e.g., items ordered, customer name, customer location, payment method, price paid, special instructions, time ordered, order number or other identifier, etc.). Such information may be used by a merchant to determine whether to confirm an order or decline an order. Such information may be used by a merchant to prepare an order (e.g., pack, label, etc.).

As a further example, information may be presented identifying quotes regarding one or more delivery networks. Displaying information about one or more delivery network quotes may be part of a request for confirmation ad/or part of a quote for a selection of a delivery network. Again, FIG. 6 illustrates such information being presented. Such information may be presented in response to receiving and/or determining such information, in response to a confirmation, together with a confirmation request and so on. For example, as illustrated in FIG. 6, delivery network quotes may be presented with order information in a confirmation request interface screen. In some implementations, delivery network quotes may be populated later (e.g., because it may take time to determine and/or receive such a quote). In some embodiments, a confirmation may be made before a selection of a delivery option sis made. For example, delivery quote information may be displayed in a subsequent interface screen to order information.

As indicated, some embodiments may include receiving confirmation of an order and/or selection of a delivery network. For example, a merchant may actuate a control on a terminal to indicate confirmation (e.g. by pressing a button). As another example, a merchant may select a delivery network from a plurality of delivery networks that provided quotes by actuating a control on a terminal (e.g., by pressing a button, selecting a check box, etc.). In some embodiments, a selection of a delivery network may act as a confirmation of an order. In some embodiments, separate confirmation may be used (e.g., before, along with, after) with a selection of a delivery network. For example, in response to determining a confirmation, a separate selection interface may be displayed through which a separate selection of a delivery network may be made by the merchant (and then subsequently received by the merchant terminal). FIG. 6 illustrates an example interface that may be used by a merchant to indicate confirmation of an order and selection of a delivery network through one interface screen. In response to a merchant operating such an interface, a merchant terminal may determine that the merchant confirms the order and selects a particular delivery network to deliver the order based on input from the merchant (e.g., pressing of one or more buttons, checking of one or more checkboxes, and/or any other actuation of any controls). Information regarding a confirmation and/or selection may be stored by a merchant terminal in some implementations. It should be understood that a variety of arrangements of confirmation and selection may be used and that various examples are nom-limiting. It should also be understood that some embodiments may not include one or more of a confirmation and/or selection. For example, some embodiments may include a proprietary delivery service rather than and/or in addition to a delivery network.

As indicated, some embodiments may include transmitting confirmation and selection. Such a transmission may be made in response to receiving a confirmation and/or selection (e.g., separately, together, etc.). In some embodiments, such a transmission may be made to a point of sale cloud service, which may subsequently use such information to facilitate delivery of the order (e.g., notify a referral service, notify a delivery network, etc.). In some embodiments, such a transmission may be made to a service provider (e.g., to a referral service that may notify a customer, to a delivery network that may delivery an order, etc.). Transmission of information may be made through an API (e.g. a call to a point of sale cloud service API, a call to a delivery network and/or referral service API). Transmitted information may be tagged with an order identifier to facilitate tracking of information regarding the order.

In some embodiments, a confirmation and selection may be made together through using an interface screen such as that of FIG. 6. In such embodiments, confirmation and selection may be transmitted together (e.g., in response to them being made through the interface screen, in a single communication, in parallel, as part of a same response to merchant action, etc.). In some embodiments, confirmation and selection may be made separately (e.g.., through a series of interface screens, through separate merchant actions, etc.). In such embodiments, confirmation and selection may be transmitted separately (e.g. in response to separate merchant actions, sequentially, in separate communications, etc.). Actions may take place in response to each separate one of confirmation and selection happening (e.g., a new interface screen being displayed requesting the next of confirmation and selection, information being obtained to populate a screen such as delivery network quotes, etc.).

As indicated, some embodiments may include facilitating order fulfillment. Such facilitation may be performed in response to an order confirmation and/or delivery network selection. Such facilitation may include any actions that may enable a merchant to fulfil the orders (e.g., using the delivery network selected). For example, such facilitation may include communicating with a point of sale cloud service and/or service providers. As another example, such facilitation may include displaying information through a merchant terminal (e.g., ordered items through a back end terminal so items may be prepared, ordered items through a front end terminal so items may be packed). As yet another example, such facilitation may include printing receipts, indicating delivery agent information (e.g., identifying a delivery agent identifier received from a delivery network to a merchant, and so on).

It should be recognized that the example of FIG. 4 is given as a non-limiting example only. Other embodiments may include no such method, a similar method, a different method, a differently ordered method, a longer method a method with different actions, and so on. For example, order confirmation may take place before and/or in parallel with delivery quotes and/or delivery network selection. Some embodiments may not include a point of sale cloud based provider. For example, a merchant terminal (or other service) may perform actions described as being taken by a point of sale cloud service. As still another example, some embodiments may allow a merchant to choose a proprietary delivery service (e.g., an employee of the merchant making the delivery rather than a delivery network). As still another example, some embodiments may include updating inventory information to reflect an order. Such an update may affect a menu of information available through a referral service. In some embodiments, a merchant location may be transmitted (e.g., upon setup, periodically, in response to a change of location, in response to a merchant entering a location, in response to a GPS determination of location, etc.). Such a location may be used to determine delivery areas, sources of orders, and so on. Any customers may place any number of orders with any number of merchants use such a method. Such examples are non-limiting. Such a method may be combined with other elements in any combination as desired.

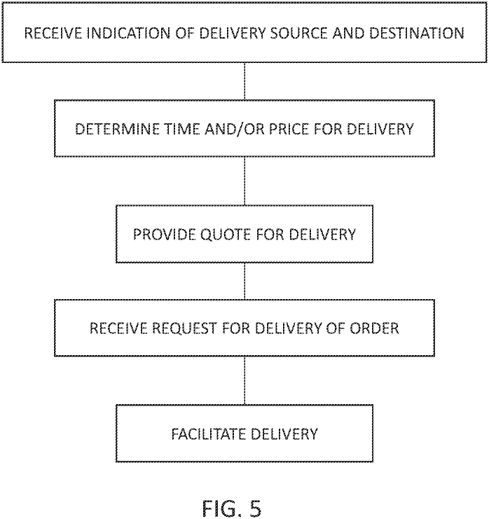

FIG. 5 illustrates an example method that may be performed in some embodiments. For example, a delivery network 109 may perform such a method in some embodiments by executing a program. Such a method may enable a delivery network to provide delivery quoting and/or services. Any number of orders may have delivery quoted and/or made using such a method. Any number of a delivery networks may provide services to any number of merchants using such a method. In some embodiments, a merchant may authorize one or more delivery networks to be used to fulfill orders (e.g., by authorizing their use through an application on a merchant terminal). In some embodiments, a set of delivery networks may be maintained without merchant authorization.

As indicated, some embodiments may include receiving an indication of a delivery source and destination. Such receipt may be part of a request for a quote for service of a delivery of an order. Such information may be received from a point of sale could service, a merchant terminal, a referral service, and so on. For example, a point of sale cloud service may make a request for quote in response to receiving an order from a referral service. Such information may be received through an API of a delivery network in some embodiments. The source may include a merchant location. The destination may include a customer location.

As indicated, some embodiments may include determining a time and/or price for delivery. Such a determination may be made in response to a receipt of the indication of the delivery source and destination. Such a determination may include referencing a price chart based on distance. Such a determination may include using an auction method to determine a price. Such a determination may include referencing an available number of delivery agents. Such a determination may include referencing a location of delivery agents. Any manner of determining a quote of a price and/or time may be used as desired.

As indicated, some embodiments may include providing a quote for the delivery. Providing the quote maybe performed in response to determining a time and/or price for delivery. Proving the quote may include transmitting a determined price and/or time to a requesting entity (e.g., using an API). Various examples of price and/or time determination and quoting are given herein. It should be recognized that any combination or manner may be used as desired in accordance with the policies of one or more delivery networks.

As indicated, some embodiments may include receiving a request for the delivery of an order. Such a request may be received from a point of sale cloud service, a merchant terminal, a referrals service, and so on (e.g., through an API of a delivery network). Such a request may indicate acceptance of a quote. An order identifier may be used to track a quote and a request for delivery. Such a request may identify a source and/or destination for a delivery.

As indicated, some embodiments may include facilitating delivery. Facilitating delivery may be performed in response to receiving the request for delivery of the order. Facilitating delivery may include notifying a delivery agent to perform the delivery. Facilitating delivery may include charging for the delivery (e.g., a quoted price). Facilitating delivery may include performing the delivery. Facilitating delivery may include transmitting information to a delivery of a selected delivery agent indicating characteristics about the order (e.g., source, destination, a quoted time).

It should be recognized that the example of FIG. 5 is given as a non-limiting example only. Other embodiments may include no such method, a similar method, a different method, a differently ordered method, a longer method a method with different actions, and so on. Any number of orders may be delivered for any number of merchants using such a method.

FIG. 6 illustrates as example interface screen that may be used in some embodiments. Such an interface screen may be presented to a merchant through a merchant terminal. The illustrated example shows that such a screen may indicate an order number. The order number may include a number that may identify the order across components of a system such as that of FIG. 1. The illustrated example shows that such a screen may indicate order details. For example, such details may include items that are part of the order, special instructions, prices of items, payment method, delivery options, delivery destination, customer information, and so on. The illustrated example shows that such a screen may indicate delivery network information. Delivery network information may include quotes for one or more delivery networks (e.g., times, prices). Any delivery network may have nay number of price and/or time combination available for choosing. A merchant may actuate a control (e.g., a checkbox in this instance) to select a delivery network. A default network (e.g., established by the merchant, sponsored by a point of sale service, having a lowest price, having an earliest time, etc.) may be preselected. In some instances, a merchant may select to use a proprietary service by delivering the order through employees. The illustrated example shows that such a screen may indicate a confirmation and/or delivery network selection control. In this example, a button may be pressed to indicate confirmation of an order and/or selection of a delivery network. In response to the actuation of the control, actions such as notifying a delivery network, a referral service, and/or a point of sale cloud service may be performed.

It should be recognized that the illustrated example of FIG. 6 is non-limiting. Other embodiments may use other interface screens. Any number of interface screens may make up an interface used for managing an order. For example, in some implementations a first screen may be used to confirm an order and a second screen may be used to select a delivery network. Any number of orders may be managed using such screens by any number of merchants.

It should be recognized that the variety of examples given herein are non-limiting. A variety of examples may operate together or independently in any arrangement or combination. Such methods and system may enable efficient menu publishing, order placement, delivery providing and point of sale services in a comprehensive manner that allows for fast paced order fulfillment across large scales of merchants and customers.

### PROCESSES AND/OR APPARATUS

### I. Terms

The term “product” means any machine, manufacture and / or composition of matter, unless expressly specified otherwise.

The term “process” means any process, algorithm, method, or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of, or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number, and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, ... 9) and non-whole numbers (e.g., 1.1, 1.2, ... 1.9).

Where two or more terms or phrases are synonymous (e.g., because of an explicit statement that the terms or phrases are synonymous), instances of one such term / phrase does not mean instances of another such term / phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed and does not imply that numerical methods must be used and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget.” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device / article (whether or not they cooperate) may alternatively be used in place of the single device / article that is described. Accordingly, the functionality that is described as being possessed by a device may alternatively be possessed by more than one device / article (whether or not they cooperate).

Similarly, where more than one device, article or other product is described herein (whether or not they cooperate), a single device / article may alternatively be used in place of the more than one device or article that is described. For example, a plurality of computer-based devices may be substituted with a single computer-based device. Accordingly, the various functionality that is described as being possessed by more than one device or article may alternatively be possessed by a single device / article.

The functionality and / or the features of a single device that is described may be alternatively embodied by one or more other devices which are described but are not explicitly described as having such functionality / features. Thus, other embodiments need not include the described device itself, but rather can include the one or more other devices which would, in those other embodiments, have such functionality / features.

### IV. Disclosed Examples and Terminology Are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim.. An Abstract has been included in this application merely because an Abstract is required under 37 C.F.R. § 1.72(b).

The title of the present application and headings of sections provided in the present application are for convenience only and are not to be taken as limiting the disclosure in any way.

Numerous embodiments are described in the present application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and / or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components / features are required. On the contrary, a variety of optional components are described to illustrate the wide variety of possible embodiments of the present invention(s). Unless otherwise specified explicitly, no component / feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and / or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing / multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and / or transmitted according to numerous formats, standards or protocols, such as Ethernet (or IEEE 802.3), SAP, ATP, Bluetooth™, and TCP/IP, TDMA, CDMA, and 3G; and / or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer / computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and / or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and / or inventions. Some of these embodiments and / or inventions may not be claimed in the present application but may nevertheless be claimed in one or more continuing applications that claim the benefit of priority of the present application.

Applicants intend to file additional applications to pursue patents for subject matter that has been disclosed and enabled but not claimed in the present application.

### VII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### VIII. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

1. An apparatus comprising:
a network link;
a computing device;
a non-transitory medium having store thereon a plurality of instructions that when executed cause the apparatus to:
receive, through the network link from a merchant computing system, a plurality of items available for purchase from the merchant;
aggregate the plurality of items into a menu for the merchant;
populate a first interface configured for ordering from the merchant at a plurality of remote client devices;
receive, through the network link, an order for the merchant for a customer and from a remote client device of the plurality of remote client device;
in response to receiving the order, request, through the network link from a plurality of delivery network systems, delivery quotes to deliver the order to the customer;
receive, through the network link and from the plurality of delivery network systems, the delivery quotes from the delivery network systems to deliver the order to the customer;
in response to receiving the order, populate a second interface for managing orders with information defining the order, requesting confirmation of the order, and requesting selection of a delivery network to deliver the order to the customer;
in response to receiving the delivery quotes, populate the second interface with at least one of cost and time from the delivery quotes for at least one of the plurality of delivery network systems;
receive, through the communication link, a confirmation of the order entered through the second interface and a selection of a delivery network to delivery network to deliver the order to the customer;
in response to receiving the confirmation and the selection of the delivery network, notify, through the communication link, the customer of the confirmation and an estimate of a time for delivery of the order by the delivery network;
in response to receiving the confirmation and the selection of the delivery network, facilitate, through the communication link, delivery of the order to the customer using the delivery network; and
process payment for the order to the merchant and payment for delivery of the order to the delivery network using payment information of the customer.
